(19) United States
(12) Patent Application Publication
(10) Pub. No.: US 2021/0356280 A1
(43) Pub. Date: Nov. 18, 2021

(54) VEHICLE ALLOCATION DEVICE, VEHICLE, AND TERMINAL

(71) Applicant: TOYOTA JIDOSHA KABUSHIKI KAISHA, Aichi-ken (JP)

(72) Inventors: Satoshi KANEKO, Gotemba-shi (JP); Daiki YOKOYAMA, Gotemba-shi (JP); Hiroshi OYAGI, Gotemba-shi (JP); Ryo NAKABAYASHI, Susono-shi (JP)

(21) Appl. No.: 17/207,547

(22) Filed: Mar. 19, 2021

(30) Foreign Application Priority Data
May 13, 2020 (JP) 2020-084800

(51) Int. Cl. G01C 21/34; G06Q 10/06; G05B 13/02; G07C 5/08

(52) U.S. Cl. CPC G01C 21/3407; G07C 5/0808; G05B 13/0265; G06Q 10/06315

(57) ABSTRACT

A vehicle allocation device allocates a vehicle in response to a vehicle allocation request from a terminal of a user. The vehicle allocation device includes a vehicle selection unit configured to select a vehicle having relatively small learning progress of an input/output relationship of parameters depending on a scheduled traveling area where the user is traveling, from a plurality of vehicles learning an input/output relationship of parameters depending on a predetermined area, and output a vehicle allocation instruction to the selected vehicle in a case where the vehicle allocation request is received.

The present application claims priority to and incorporates by reference the entire contents of Japanese Patent Application No. 2020-084800 filed in Japan on May 13, 2020.

### BACKGROUND

The present disclosure relates to a vehicle allocation device, a vehicle, and a terminal.

A technique of preferentially allocating a vehicle that has small progress in hydraulic control learning in a system of allocating a vehicle having a hydraulic control learning function of a power transmission device is disclosed in JP 2019-032625 A.

### SUMMARY

Since the hydraulic control learning disclosed in JP 2019-032625 A does not depend on an area in which a vehicle travels, the learning may be efficiently performed during vehicle allocation. However, the technique disclosed in JP 2019-032625 A has a problem that it is not possible to efficiently perform learning depending on an area in which a vehicle travels, such as learning of a pavement condition of a road.

There is a need for a vehicle allocation device, a vehicle, and a terminal capable of efficiently performing learning during vehicle allocation.

According to one aspect of the present disclosure, there is provided a vehicle allocation device for allocating a vehicle in response to a vehicle allocation request from a terminal of a user, the vehicle allocation device including a vehicle selection unit configured to select a vehicle having relatively small learning progress of an input/output relationship of parameters depending on a scheduled traveling area where the user is traveling, from a plurality of vehicles learning an input/output relationship of parameters depending on a predetermined area, and output a vehicle allocation instruction to the selected vehicle in a case where the vehicle allocation request is received.

According to another aspect of the present disclosure, there is provided a vehicle adapted to be allocated by a vehicle allocation device in response to a vehicle allocation request from a terminal of a user, the vehicle including circuitry configured to: learn an input/output relationship of parameters depending on a predetermined area; and acquire a vehicle allocation instruction from the vehicle allocation device in a case where learning progress of an input/output relationship of parameters depending on a scheduled traveling area where the user is traveling is relatively small compared to other vehicles to be allocated.

According to still another aspect of the present disclosure, there is provided a terminal for making a vehicle allocation request to a vehicle allocation device, the terminal including: a vehicle allocation reservation unit configured to receive a vehicle allocation reservation from a user, output the vehicle allocation request to the vehicle allocation device based on the vehicle allocation reservation, and acquire, by outputting the vehicle allocation request to the vehicle allocation device, as allocation-scheduled vehicle information, information related to a vehicle that is selected from a plurality of vehicles learning an input/output relationship of parameters depending on a predetermined area and that has relatively small learning progress of an input/output relationship of parameters depending on a scheduled traveling area where the user is traveling.

### BRIEF DESCRIPTION OF THE DRAWINGS

FIG. 1 is a view schematically illustrating a vehicle allocation system that includes a vehicle allocation device, a vehicle, and a terminal and that is according to a first embodiment;

FIG. 2 is a block diagram schematically illustrating each configuration of the vehicle allocation system according to the first embodiment;

FIG. 3 is a view for describing an example of a neural network;

FIG. 4 is a view for describing an outline of a vehicle allocation method executed by the vehicle allocation system according to the first embodiment;

FIG. 5 is a view illustrating an example of a vehicle allocation reservation screen displayed on the terminal in the vehicle allocation method executed by the vehicle allocation system according to the first embodiment;

FIG. 6 is a view illustrating an example of allocation-scheduled vehicle information displayed on the terminal in the vehicle allocation method executed by the vehicle allocation system according to the first embodiment;

FIG. 7 is a flowchart illustrating a flow of when teacher data is collected and learned in the vehicle allocation method executed by the vehicle allocation system according to the first embodiment;

FIG. 8 is a flowchart illustrating a flow of when a vehicle allocation reservation is made in the vehicle allocation method executed by the vehicle allocation system according to the first embodiment;

FIG. 9 is a block diagram schematically illustrating each configuration of a vehicle allocation system according to a second embodiment; and

FIG. 10 is a flowchart illustrating a flow of when a vehicle allocation reservation is made in a vehicle allocation method executed by the vehicle allocation system according to the second embodiment.

### DETAILED DESCRIPTION

A vehicle allocation device, vehicle, and terminal according to embodiments will be described with reference to the drawings. Note that components in the following embodiments include what may be easily replaced by those skilled in the art or what is substantially the same.

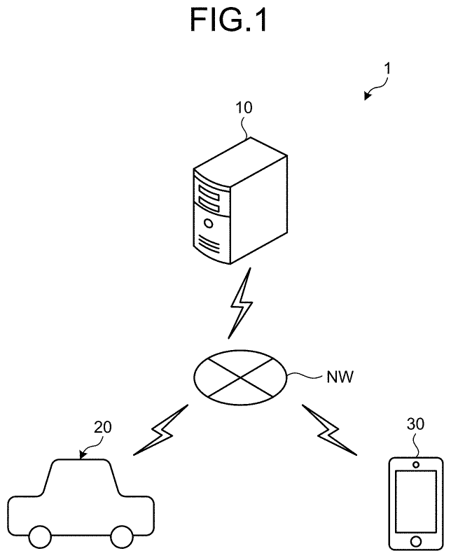

A vehicle allocation system according to the first embodiment will be described with reference to FIG. 1 to FIG. 6. As illustrated in FIG. 1, a vehicle allocation system 1 according to the embodiment includes a vehicle allocation device 10, a vehicle 20, and a terminal 30. All of the vehicle allocation device 10, the vehicle 20, and the terminal 30 have a communication function and are configured to be able to communicate with each other through a network NW. This network NW includes, for example, the Internet, a mobile phone network, and the like.

The vehicle allocation device 10 is a device to allocate the vehicle 20 to a user of the terminal 30 in response to a vehicle allocation request from the terminal 30. The vehicle allocation device 10 is realized by a general-purpose computer such as a workstation or a personal computer.

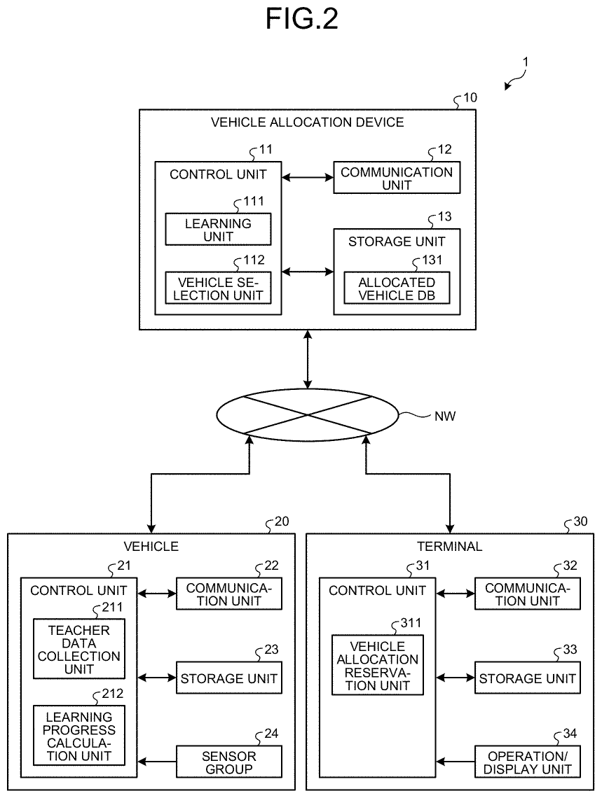

As illustrated in FIG. 2, the vehicle allocation device 10 includes a control unit 11, a communication unit 12, and a storage unit 13. More specifically, the control unit 11 includes a processor including a central processing unit (CPU), a digital signal processor (DSP), a field-programmable gate array (FPGA), and the like, and a memory (main storage unit) including a random access memory (RAM), a read only memory (ROM), and the like.

The control unit 11 realizes a function that meets a predetermined purpose by loading and executing a program, which is stored in the storage unit 13, in a work area of the main storage unit and controlling each configuration unit and the like through execution of the program. More specifically, the control unit 11 functions as a learning unit 111 and a vehicle selection unit 112 through the execution of the program described above.

The learning unit 111 learns teacher data. The learning unit 111 acquires parameters (learning value), which are collected by each vehicle 20, through the network NW from a plurality of vehicles 20 to be allocated. These parameters are parameters depending on an environment of a predetermined area and include, for example, air temperature, humidity, air pressure, a grade, altitude, an intake air amount of an engine, ignition timing of the engine, an exhaust gas temperature of the engine, and the like. Moreover, the “environment of a predetermined area” indicates, for example, a pavement condition of a road, inclination of the road, altitude of the road, and the like.

Subsequently, the learning unit 111 creates a learned model by performing machine learning with the above parameters as teacher data. Then, the learning unit 111 outputs the created learned model to each vehicle 20 through the network NW. In such a manner, since the teacher data is learned on a side of the vehicle allocation device 10, a calculation load on a side of the vehicle 20 is reduced.

A machine learning method in the learning unit 111 is not specifically limited, and supervised learning such as a neural network, support vector machine, decision tree, simple Bayes, and k-nearest neighbors algorithm may be used. Moreover, semi-supervised learning may be used instead of supervised learning.

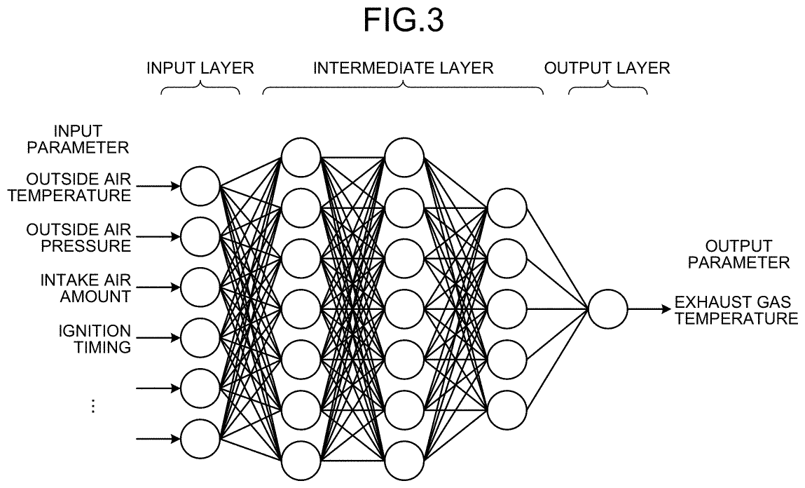

In the following, a neural network will be described as an example of a specific machine learning method. As illustrated in FIG. 3, the neural network has an input layer, an intermediate layer, and an output layer. The input layer includes a plurality of nodes, and different input parameters are respectively input to the nodes. An output from the input layer is input to the intermediate layer. Moreover, the intermediate layer has a multi-layer structure that includes layers having a plurality of nodes to receive the input from the input layer. The output layer receives an output from the intermediate layer and outputs an output parameter. Machine learning using a neural network in which the intermediate layer has a multi-layer structure is called deep learning. An example in which input parameters are an “outside air temperature, outside air pressure, intake air amount, and ignition timing” and an output parameter is an “exhaust gas temperature” is illustrated in the drawing. The learning unit 111 creates a learned model by learning a relationship between these input parameters and the output parameter.

Note that the outside air temperature and the outside air pressure illustrated as the input parameters in FIG. 3 are values unique to the area (values that characterize the area). Thus, when the outside air temperature and the outside air pressure unique to the area are reflected on the learning, a learned model of estimating an exhaust gas temperature more adapted to the area may be created.

The vehicle selection unit 112 selects a vehicle 20 to be allocated to the user of the terminal 30 from the plurality of vehicles 20. In a case of acquiring a vehicle allocation request from the terminal 30 through the network NW, the vehicle selection unit 112 selects, from a plurality of vehicles 20 that learns an input/output relationship of parameters depending on a predetermined area, a vehicle 20 having relatively small (slow) learning progress of an input/output relationship of parameters depending on a scheduled traveling area where the user travels.

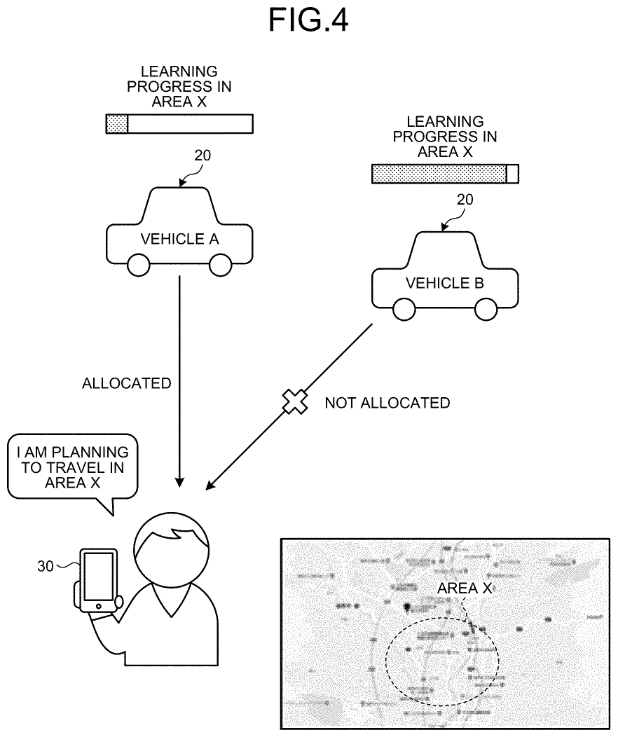

For example, as illustrated in FIG. 4, in a case where the user plans to travel in an area X, the vehicle selection unit 112 selects, from a vehicle A and a vehicle B that perform learning in the area X during vehicle allocation, the vehicle A having the smallest learning progress in the area X. Then, the vehicle selection unit 112 outputs information related to the selected vehicle A (hereinafter, referred to as “allocation-scheduled vehicle information”) to the terminal 30 of the user, and outputs a vehicle allocation instruction to the selected vehicle A. Note that extent of an “area” in the embodiment is preferably extent with which a difference is generated in the parameters (such as air temperature, humidity, air pressure, grade, and altitude) collected by the vehicles 20 (for example, basin level).

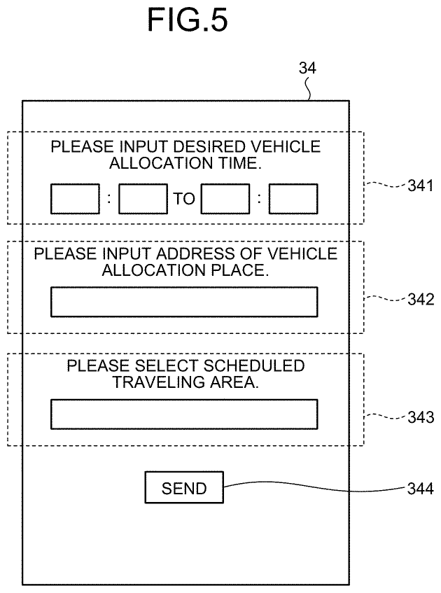

Here, the scheduled traveling area of the user is selected by the user himself/herself through a vehicle allocation reservation screen (see FIG. 5) displayed on an operation/display unit 34 of the terminal 30, as described later. In this selection of a scheduled traveling area, for example, a municipality or the like where the vehicle 20 is scheduled to travel may be selected or information that may identify an area, such as a zip code may be input.

Moreover, learning progress is acquired from each vehicle 20. That is, a vehicle 20 calculates learning progress based on the number of pieces and an acquisition time of teacher data collected by the own vehicle. Then, when selecting a vehicle 20, the vehicle selection unit 112 acquires the learning progress from each vehicle 20 and selects the vehicle 20 based on the acquired learning progress. In such a manner, by acquiring the learning progress from each vehicle 20, it is possible to grasp on the side of the vehicle allocation device 10 how much learning is progressed in each vehicle 20.

The communication unit 12 includes, for example, a local area network (LAN) interface board, a wireless communication circuit for wireless communication, and the like. The communication unit 12 is connected to the network NW that is a public communication network, such as the Internet. Then, the communication unit 12 communicates with a vehicle 20 and a terminal 30 by being connected to the network NW.

The storage unit 13 includes recording media such as an erasable programmable ROM (EPROM), a hard disk drive (HDD), and a removable medium. Examples of the removable media include a universal serial bus (USB) memory, and disc recording media such as a compact disc (CD), a digital versatile disc (DVD), and a Blu-ray (registered trademark) disc (BD). The storage unit 13 may store an operating system (OS), various programs, various tables, various databases, and the like.

The storage unit 13 includes an allocated vehicle database (DB) 131. The allocated vehicle DB 131 is constructed when a program of a database management system (DBMS) which program is executed by the control unit 11 manages data stored in the storage unit 13. The allocated vehicle DB 131 includes, for example, a relational database in which the learning progress of each vehicle 20 is stored in a searchable manner.

Moreover, in addition to the allocated vehicle DB 131, teacher data acquired from the vehicles 20 through the network NW, a learned model created by the learning unit 111, and the like are stored in the storage unit 13 when necessary.

The vehicle 20 is a mobile body capable of communicating with the outside, and is a vehicle to be allocated to a user of the terminal 30 in response to a vehicle allocation request from the terminal 30. This vehicle 20 may be either a manually driven vehicle or an automatically driven vehicle.

More specifically, the vehicle 20 learns an input/output relationship of parameters depending on a predetermined area, and outputs a learning result to the vehicle allocation device 10. Note that in the embodiment, “learning” performed by the vehicle 20 means collecting various parameters during traveling (during vehicle allocation) and creating teacher data. The “learning result” output to the vehicle allocation device 10 specifically means the teacher data.

The vehicle 20 acquires a vehicle allocation instruction from the vehicle allocation device 10 in a case where learning progress of teacher data related to a scheduled traveling area in which the user travels is relatively small compared to the other vehicles 20 to be allocated. Note that the vehicle 20 may acquire a vehicle allocation instruction from the vehicle allocation device 10 in a case where the learning progress of the teacher data related to the scheduled traveling area in which the user travels is the smallest compared to the other vehicle 20 to be allocated.

As illustrated in FIG. 2, the vehicle 20 includes a control unit 21, a communication unit 22, a storage unit 23, and a sensor group 24. The control unit 21 is an electronic control unit (ECU) that comprehensively controls operations of various components mounted on the vehicle 20. The control unit 21 functions as a teacher data collection unit 211 and a learning progress calculation unit 212 through execution of a program stored in the storage unit 23.

The teacher data collection unit 211 collects teacher data depending on a predetermined area. Note that the “teacher data” indicates, in the embodiment, a set of input parameters and output parameters necessary for machine learning. In such a manner, the teacher data collection unit 211 collects teacher data for learning and sequentially performs an output thereof to the vehicle allocation device 10, whereby it is possible to learn various parameters depending on a predetermined area.

More specifically, the teacher data collection unit 211 collects raw data of parameters by a sensor group 24 during traveling, and creates teacher data by performing predetermined preprocessing or the like. Then, the teacher data collection unit 211 outputs the created teacher data to the vehicle allocation device 10 through the network NW.

The learning progress calculation unit 212 calculates learning progress based on the number of pieces and an acquisition time of teacher data collected by the vehicle 20. Then, the learning progress calculation unit 212 outputs the calculated learning progress to the vehicle allocation device 10 at predetermined time intervals, for example. More specifically, the learning progress calculation unit 212 calculates the learning progress by the following equation (1).

LEARNING PROGRESS=A×NUMBER OF PIECES OF TEACHER DATA+F×AVERAGE ACQUISITION TIME (1)
WHERE A: PREDETERMINED VALUE AND F: CONVERSION COEFFICIENT

Moreover, as illustrated in Table 1 below, the learning progress calculation unit 212 sets a conversion coefficient F of the above equation (1) in such a manner that learning progress becomes smaller (slower) as an average acquisition time of teacher data becomes older (later). As a result, the learning progress may be calculated based on freshness of the collected teacher data.

TABLE 1

| | Number of | | |
|---|---|---|---|
| | pieces of | Average | |
| | teacher data | acquisition | Learning |
| Vehicle | (Piece) | time | progress |
| Vehicle A | 1000 | 2019 Nov. 12 | 20 |
| Vehicle B | 700 | 2019 Dec. 12 | 90 |
| Vehicle C | 1600 | 2019 Oct. 3 | 0 |
| . . . | . . . | . . . | . . . |

The communication unit 22 includes, for example, a data communication module (DCM) and the like, and performs communication with the vehicle allocation device 10 and the terminal 30 by wireless communication through the network NW. When necessary, the storage unit 23 stores, for example, raw data of parameters collected by the teacher data collection unit 211, teacher data created by the teacher data collection unit 211, learning progress calculated by the learning progress calculation unit 212, and the like.

The sensor group 24 is to detect and record parameters during traveling of the vehicle 20 and includes, for example, a vehicle speed sensor, an acceleration sensor, a GPS sensor, a traveling space sensor (3D-LiDAR), a millimeter wave sensor, a camera (imaging device), a temperature sensor, a humidity sensor, an air pressure sensor, and the like. The sensor group 24 outputs raw data of the detected parameters to the teacher data collection unit 211.

The terminal 30 is a terminal device to make a vehicle allocation request to the vehicle allocation device 10 based on operation by a user. For example, the terminal 30 is realized by a smartphone, a mobile phone, a tablet terminal, a wearable computer, or the like owned by the user of the vehicle 20. As illustrated in FIG. 2, the terminal 30 includes a control unit 31, a communication unit 32, a storage unit 33, and an operation/display unit 34. The control unit 31 functions as a vehicle allocation reservation unit 311 through execution of a program stored in the storage unit 33.

The vehicle allocation reservation unit 311 causes the operation/display unit 34 to display a vehicle allocation reservation screen, and receives a vehicle allocation reservation from the user through the vehicle allocation reservation screen. Subsequently, the vehicle allocation reservation unit 311 outputs a vehicle allocation request (vehicle allocation reservation information) to the vehicle allocation device 10 based on the vehicle allocation reservation. This vehicle allocation request includes, for example, a desired vehicle allocation time, an address of a vehicle allocation place, a scheduled traveling area, a destination, and information for identifying a user (such as name and ID).

Subsequently, as allocation-scheduled vehicle information, the vehicle allocation reservation unit 311 acquires, from the vehicle allocation device 10, information related to a vehicle 20 that is selected from a plurality of vehicles 20 learning an input/output relationship of parameters depending on a predetermined area, and that has relatively small learning progress of an input/output relationship of parameters depending on a scheduled traveling area where the user travels. Then, the vehicle allocation reservation unit 311 causes the operation/display unit 34 to display this allocation-scheduled vehicle information. Note that as the allocation-scheduled vehicle information, the vehicle allocation reservation unit 311 may acquire, from the vehicle allocation device 10, information related to a vehicle 20 having the smallest learning progress of the input/output relationship of parameters depending on the scheduled traveling area where the user travels.

In making of a vehicle allocation reservation, the vehicle allocation reservation unit 311 causes the operation/display unit 34 to display a vehicle allocation reservation screen such as what is illustrated in FIG. 5, for example. This vehicle allocation reservation screen is displayed, for example, when the user taps an icon of a vehicle allocation application displayed on the operation/display unit 34 and activates the vehicle allocation application. On the vehicle allocation reservation screen illustrated in the drawing, an entry field for a desired vehicle allocation time is displayed in a region 341, an entry field for an address of a vehicle allocation place is displayed in a region 342, an entry field for a scheduled traveling area is displayed in a region 343, and a send button 344 is displayed at the bottom. Note that in addition to the entries illustrated in the drawing, the vehicle allocation reservation unit 311 may display an entry field for a destination or information to identify a user (such as name or ID), for example.

When all the entries on the vehicle allocation reservation screen are input and the send button 344 is pressed by the user, the vehicle allocation reservation unit 311 outputs a vehicle allocation request including the information input to these entries to the vehicle allocation device 10.

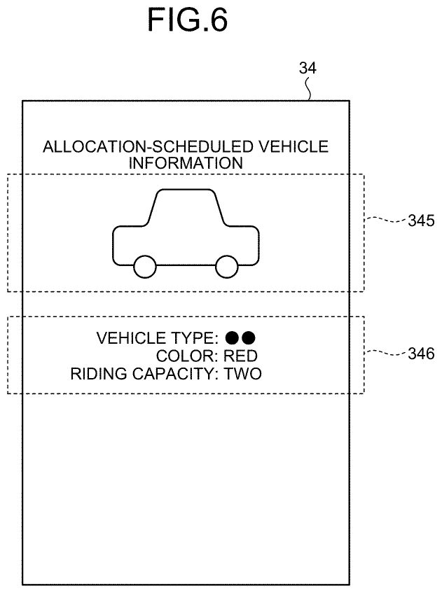

The vehicle selection unit 112 of the vehicle allocation device 10 that acquires the vehicle allocation request selects an allocation-scheduled vehicle with reference to the allocated vehicle DB 131, and causes the operation/display unit 34 to display allocation-scheduled vehicle information such as what is illustrated in FIG. 6, for example. In the allocation-scheduled vehicle information illustrated in the drawing, an image of the allocation-scheduled vehicle is displayed in a region 345, and a vehicle type, color, and riding capacity are displayed in a region 346.

The communication unit 32 communicates with the vehicle allocation device 10 and the vehicle 20 by wireless communication through the network NW. The storage unit 33 stores, for example, an application program (vehicle allocation application) to realize the vehicle allocation reservation unit 311.

The operation/display unit 34 includes, for example, a touch panel display or the like, and has an input function of receiving operation by a finger of an occupant of the vehicle 20, a pen, or the like, and a display function of displaying various kinds of information under the control of the control unit 31. The operation/display unit 34 displays the vehicle allocation reservation screen (see FIG. 5) and the allocation-scheduled vehicle information (see FIG. 6) under the control of the vehicle allocation reservation unit 311.

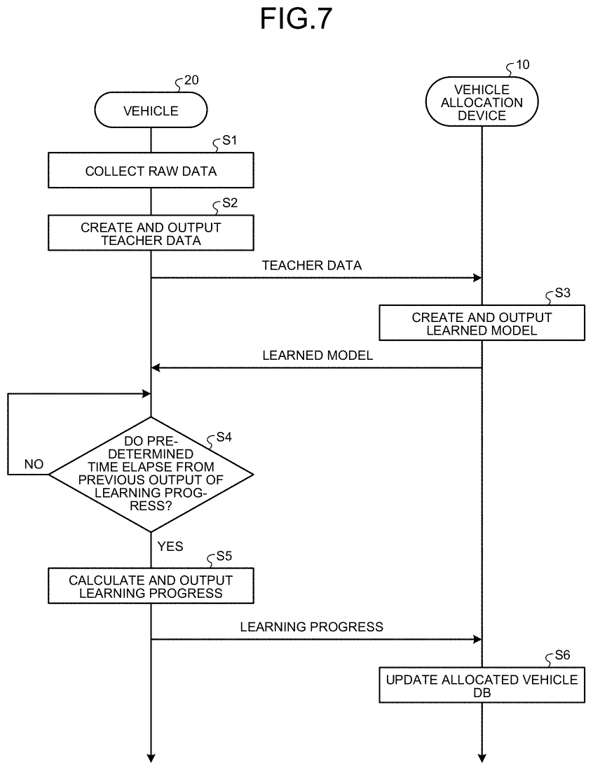

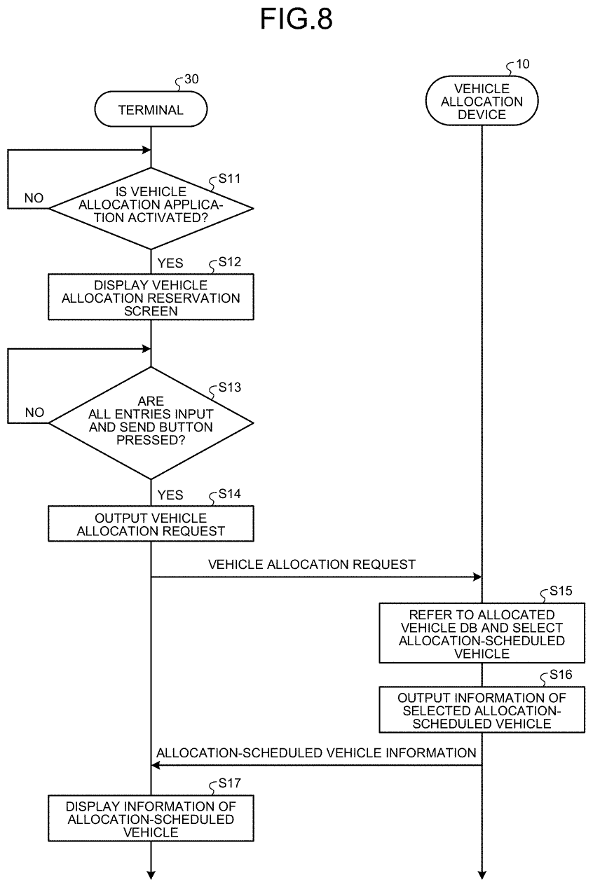

An example of a processing procedure of the vehicle allocation method executed by the vehicle allocation system 1 according to the embodiment will be described with reference to FIG. 7 and FIG. 8. In the following, with respect to the vehicle allocation system 1, a flow of a step of collecting and learning teacher data by using a vehicle 20 (hereinafter, referred to as “learning step”) will be described with reference to FIG. 7, and a flow of a step of making a vehicle allocation reservation (hereinafter, referred to as “vehicle allocation reservation step”) will be described with reference to FIG. 8. Moreover, in the following vehicle allocation reservation step, an example of a case where a vehicle 20 having the smallest learning progress is preferentially allocated will be described.

First, a teacher data collection unit 211 of a vehicle 20 collects raw data of parameters in a predetermined area through a sensor group 24 (Step S1). Subsequently, the teacher data collection unit 211 creates teacher data from the raw data and outputs the created teacher data to a vehicle allocation device 10 (Step S2). Subsequently, a learning unit 111 of the vehicle allocation device 10 creates a learned model by performing machine learning on the teacher data, and outputs the created learned model to the vehicle 20 (Step S3).

Subsequently, a learning progress calculation unit 212 of the vehicle 20 determines whether a predetermined time elapses from a previous output of learning progress to the vehicle allocation device 10 (Step S4). In a case where it is determined that the predetermined time elapses from the previous output of learning progress to the vehicle allocation device 10 (Yes in Step S4), the learning progress calculation unit 212 calculates learning progress based on the above equation (1) and outputs the calculated learning progress to the vehicle allocation device 10 (Step S5). In response to this, a control unit 11 of the vehicle allocation device 10 updates an allocated vehicle DB 131 by storing the learning progress into the allocated vehicle DB 131 (Step S6). Note that in a case where it is determined that the predetermined time does not elapse from the previous output of learning progress to the vehicle allocation device 10 (No in Step S4), the learning progress calculation unit 212 returns to Step S4. From the above, the processing of the learning step of the vehicle allocation method is ended.

First, a vehicle allocation reservation unit 311 of a terminal 30 determines whether a user activates a vehicle allocation application, for example, by tapping an icon of the vehicle allocation application which icon is displayed on an operation/display unit 34 (Step S11). In a case where it is determined that the vehicle allocation application is activated (Yes in Step S11), the vehicle allocation reservation unit 311 causes the operation/display unit 34 to display the vehicle allocation reservation screen (see FIG. 5) (Step S12). Note that in a case where it is determined that the vehicle allocation application is not activated (No in Step S11), the vehicle allocation reservation unit 311 returns to Step S11.

Subsequently, the vehicle allocation reservation unit 311 determines whether all entries on the vehicle allocation reservation screen are input and a send button 344 is pressed (Step S13). In a case where it is determined that all the entries on the vehicle allocation reservation screen are input and the send button 344 is pressed (Yes in Step S13), the vehicle allocation reservation unit 311 outputs a vehicle allocation request to the vehicle allocation device 10 (Step S14). Note that in a case where it is determined that any of the entries on the vehicle allocation reservation screen is not input or the send button 344 is not pressed (No in Step S13), the vehicle allocation reservation unit 311 returns to Step S13.

Subsequently, a vehicle selection unit 112 of the vehicle allocation device 10 refers to the allocated vehicle DB 131 and selects an allocation-scheduled vehicle (Step S15). In Step S15, the vehicle selection unit 112 selects, from a plurality of vehicles 20 that learns an input/output relationship of parameters depending on a predetermined area, a vehicle 20 having the smallest learning progress of an input/output relationship of parameters depending on a scheduled traveling area where the user travels. That is, the vehicle selection unit 112 first narrows down the plurality of vehicles 20 to vehicles 20 learning an input/output relationship of parameters depending on the scheduled traveling area included in the vehicle allocation request. Then, the vehicle selection unit 112 refers to the allocated vehicle DB 131 and selects, as an allocation-scheduled vehicle, a vehicle 20 having the smallest learning progress among the narrowed vehicles 20.

Subsequently, the vehicle selection unit 112 outputs information of the selected allocation-scheduled vehicle to the terminal 30 (Step S16). In response to this, the vehicle allocation reservation unit 311 causes the operation/display unit 34 to display the allocation-scheduled vehicle information (see FIG. 6) (Step S17). Note that in Step S16, the vehicle selection unit 112 outputs the allocation-scheduled vehicle information to the terminal 30, and also outputs a vehicle allocation instruction to the selected vehicle 20. From the above, the processing of the vehicle allocation reservation step of the vehicle allocation method is ended.

According to the vehicle allocation device 10, the vehicle 20, and the terminal 30 of the first embodiment described above, a vehicle 20 in which learning of a scheduled traveling area is not progressed among vehicles 20 to be allocated is preferentially allocated. Thus, learning may be performed efficiently during vehicle allocation, and a learning delay in each vehicle 20 is eliminated.

In a case where a vehicle that performs AI learning is allocated, a learning condition varies between vehicles to be allocated. Thus, a condition in which learning is not performed in a certain area extremely may be generated depending on a vehicle. On the one hand, according to the vehicle allocation device 10, the vehicle 20, and the terminal 30 of the first embodiment, a vehicle 20 in which learning is not progressed is preferentially allocated. Thus, it is possible to control a condition in which learning is not performed in a certain area.

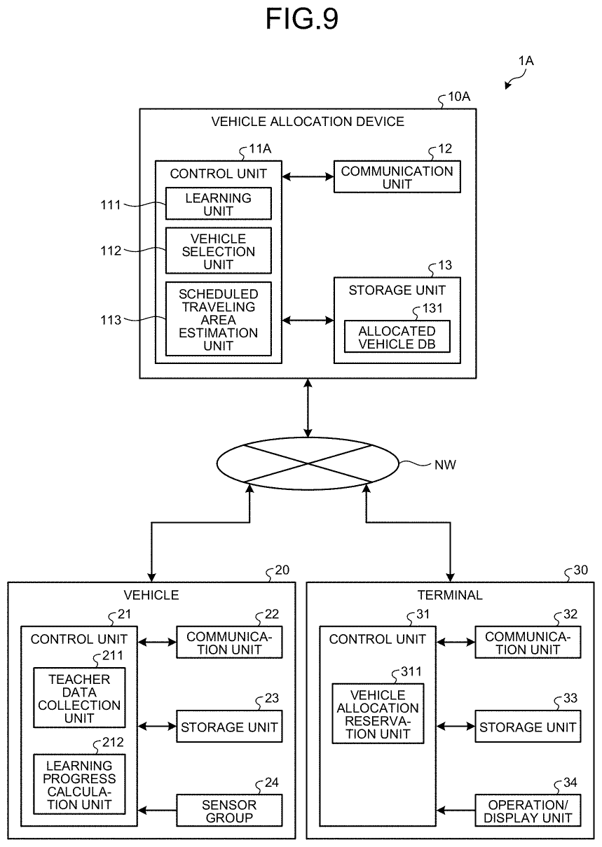

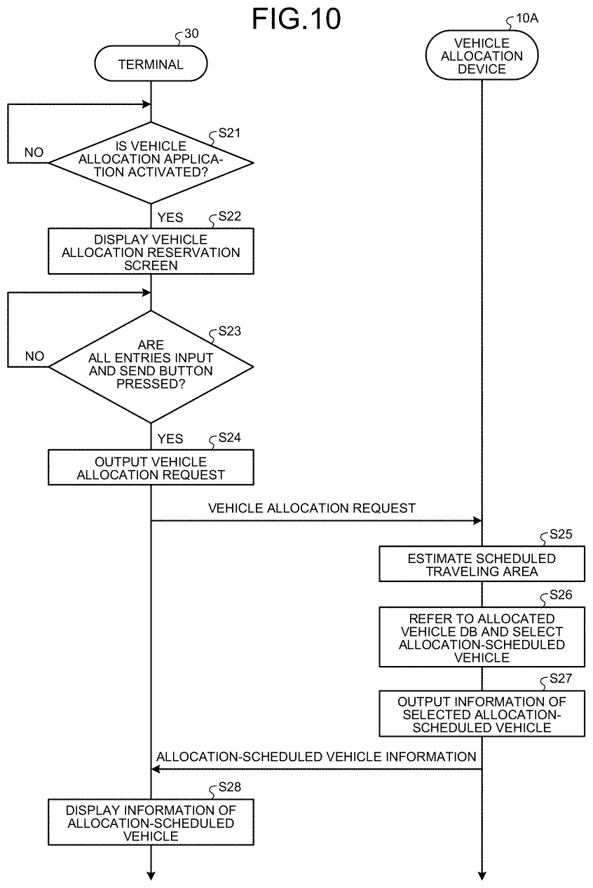

A vehicle allocation system according to the second embodiment will be described with reference to FIG. 9 and FIG. 10. As illustrated in FIG. 9, a vehicle allocation system 1A according to the embodiment includes a vehicle allocation device 10A, a vehicle 20, and a terminal 30. All of the vehicle allocation device 10A, the vehicle 20, and the terminal 30 have a communication function, and are configured to be able to communicate with each other through a network NW. In the following, a description of a configuration similar to that of the vehicle allocation system 1 (see FIG. 2) described above will be omitted.

As illustrated in FIG. 9, the vehicle allocation device 10A includes a control unit 11A, a communication unit 12, and a storage unit 13. The control unit 11A functions as a scheduled traveling area estimation unit 113 in addition to a learning unit 111 and a vehicle selection unit 112.

The scheduled traveling area estimation unit 113 estimates a scheduled traveling area of the vehicle 20 based on information related to a destination included in a vehicle allocation request. Note that the scheduled traveling area may be estimated in consideration of information other than the destination. For example, an area where a user often passes when traveling to the destination included in the vehicle allocation request may be estimated as the scheduled traveling area. The “area where a user often passes” at that time may be collected in advance as user information and stored in the storage unit 13. In such a manner, since the scheduled traveling area estimation unit 113 estimates a traveling area of the vehicle 20, it is not necessary for the user to specify a scheduled traveling area by himself/herself at the time of vehicle allocation, and time of the user is saved.

An example of a processing procedure of the vehicle allocation method executed by the vehicle allocation system 1A according to the embodiment will be described with reference to FIG. 10. Note that a flow of a learning step in the vehicle allocation system 1A is similar to that of the first embodiment (see FIG. 7). A flow of a vehicle allocation reservation step will be described in the following. Moreover, in the following vehicle allocation reservation step, an example of a case where a vehicle 20 having the smallest learning progress is selected and allocated will be described.

First, a vehicle allocation reservation unit 311 of a terminal 30 determines whether a user activates a vehicle allocation application, for example, by tapping an icon of the vehicle allocation application which icon is displayed on an operation/display unit 34 (Step S21). In a case where it is determined that the vehicle allocation application is activated (Yes in Step S21), the vehicle allocation reservation unit 311 causes the operation/display unit 34 to display a vehicle allocation reservation screen (see FIG. 5) (Step S22). Note that in a case where it is determined that the vehicle allocation application is not activated (No in Step S21), the vehicle allocation reservation unit 311 returns to Step S21.

Subsequently, the vehicle allocation reservation unit 311 determines whether all entries on the vehicle allocation reservation screen are input and a send button 344 is pressed (Step S23). In a case where it is determined that all the entries on the vehicle allocation reservation screen are input and the send button 344 is pressed (Yes in Step S23), the vehicle allocation reservation unit 311 outputs a vehicle allocation request to a vehicle allocation device 10A (Step S24). Note that in a case where it is determined that any of the entries on the vehicle allocation reservation screen is not input or the send button 344 is not pressed (No in Step S23), the vehicle allocation reservation unit 311 returns to Step S23.

Subsequently, a scheduled traveling area estimation unit 113 of the vehicle allocation device 10A estimates a scheduled traveling area of a vehicle 20 based on information related to a destination included in a vehicle allocation request (Step S25). Subsequently, a vehicle selection unit 112 refers to an allocated vehicle DB 131 and selects an allocation-scheduled vehicle (Step S26). In Step S26, the vehicle selection unit 112 first narrows down a plurality of vehicles 20 to vehicles 20 learning an input/output relationship of parameters depending on the scheduled traveling area estimated in Step S25. Then, the vehicle selection unit 112 refers to the allocated vehicle DB 131 and selects, as an allocation-scheduled vehicle, a vehicle 20 having the smallest learning progress among the narrowed vehicles 20.

Subsequently, the vehicle selection unit 112 outputs information of the selected allocation-scheduled vehicle to the terminal 30 (Step S27). In response to this, the vehicle allocation reservation unit 311 causes the operation/display unit 34 to display allocation-scheduled vehicle information (see FIG. 6) (Step S28). Note that in Step S27, the vehicle selection unit 112 outputs the allocation-scheduled vehicle information to the terminal 30, and also outputs a vehicle allocation instruction to the selected vehicle 20. From the above, the processing of the vehicle allocation reservation step of the vehicle allocation method is ended.

According to the vehicle allocation device 10A, the vehicle 20, and the terminal 30 of the second embodiment described above, a vehicle 20 in which learning of a scheduled traveling area is not progressed among vehicles 20 to be allocated is preferentially allocated. Thus, learning may be performed efficiently during vehicle allocation, and a learning delay in each vehicle 20 is eliminated.

Further effects and modification examples may be easily derived by those skilled in the art. Accordingly, broader aspects of the present disclosure are not limited by the specific details and representative embodiments that are illustrated and described in the above manner. Thus, various modifications may be made without departing from the spirit or scope of a general concept of the disclosure defined by the accompanying claims and an equivalent thereof.

For example, in the vehicle allocation reservation steps (see FIG. 8 and FIG. 10) of the vehicle allocation systems 1 and 1A described above, a case where a vehicle 20 having the smallest learning progress is selected and allocated has been described. However, selection from vehicles 20 having learning progress smaller than predetermined progress may be performed according to a different condition. Alternatively, it may be determined whether vehicle allocation may be performed in order from a vehicle 20 having the smallest learning progress and a vehicle 20 that is first determined that allocation may be performed may be selected.

Moreover, in the vehicle allocation systems 1 and 1A described above, collection of raw data and creation of teacher data are performed on a side of a vehicle 20, and learning of the teacher data and creation of learned data are performed on a side of vehicle allocation devices 10 and 10A. However, a subject of creating teacher data and a subject of learning are not limited to these.

In vehicle allocation systems 1 and 1A, for example, collection of raw data may be performed on a side of a vehicle 20, and creation of teacher data, learning of the teacher data, and creation of learned data may be performed on a side of vehicle allocation devices 10 and 10A. Moreover, all of collection of raw data, creation of teacher data, learning of the teacher data, and creation of learned data may be performed on a side of a vehicle 20.

Moreover, various parameters are collected by a teacher data collection unit 211 of a vehicle 20 in each of the vehicle allocation systems 1 and 1A. However, various parameters may be acquired and used by road-to-vehicle communication or vehicle-to-vehicle communication, for example.

Moreover, as expressed in the above equation (1), learning progress is calculated based on the number of pieces of teacher data and an average acquisition time thereof in each of the vehicle allocation systems 1 and 1A. However, instead of an average acquisition time of teacher data, a median of acquisition times of teacher data, the oldest acquisition time of the teacher data, or the latest acquisition time of the teacher data may be used.

Moreover, the vehicle allocation systems 1 and 1A described above have been described on the assumption of a scene in which a vehicle is allocated to a user on a general public road. However, for example, it is also possible to apply vehicle allocation systems 1 and 1A to a vehicle allocation service using a self-driving vehicle in a connected city or the like in which all goods and services are connected with information.

According to the present disclosure, a vehicle in which learning of a scheduled traveling area is not progressed is preferentially allocated. Thus, the learning may be efficiently performed during the allocation and a learning delay in each vehicle is eliminated.

Moreover, a vehicle in which learning of a scheduled traveling area is not relatively progressed among vehicles to be allocated is likely to be preferentially allocated.

Moreover, a vehicle in which learning of a scheduled traveling area is the least progressed among vehicles to be allocated is preferentially allocated.

Moreover, a user does not need to specify a scheduled traveling area by himself/herself at the time of vehicle allocation, and time of the user is saved.

Moreover, teacher data is learned on a side of a vehicle allocation device and a calculation load on a side of a vehicle is reduced.

Moreover, it is possible for a side of a vehicle allocation device to grasp how much learning is progressed in each vehicle.

Moreover, it is possible to learn various parameters depending on a predetermined area.

Moreover, a vehicle in which learning of a scheduled traveling area is not relatively progressed among vehicles to be allocated is likely to be preferentially allocated.

Moreover, a vehicle in which learning of a scheduled traveling area is the least progressed among vehicles to be allocated is preferentially allocated.

Moreover, each vehicle may collect teacher data and calculate learning progress simultaneously and may perform transmission thereof to a side of a vehicle allocation device.

Moreover, it is possible to learn various parameters depending on a predetermined area.

Moreover, a vehicle in which learning of a scheduled traveling area is not relatively progressed among vehicles to be allocated is likely to be preferentially allocated.

Moreover, a vehicle in which learning of a scheduled traveling area is the least progressed among vehicles to be allocated is preferentially allocated.

Moreover, it is possible to learn various parameters depending on a predetermined area.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle allocation device for allocating a vehicle in response to a vehicle allocation request from a terminal of a user, the vehicle allocation device comprising
a vehicle selection unit configured to
select a vehicle having relatively small learning progress of an input/output relationship of parameters depending on a scheduled traveling area where the user is traveling, from a plurality of vehicles learning an input/output relationship of parameters depending on a predetermined area, and
output a vehicle allocation instruction to the selected vehicle in a case where the vehicle allocation request is received.

2. The vehicle allocation device according to claim 1, wherein the vehicle selection unit is configured to
select, from the plurality of vehicles, a vehicle having smallest learning progress of the input/output relationship of the parameters depending on the scheduled traveling area where the user is traveling, and
output the vehicle allocation instruction to the selected vehicle.

3. The vehicle allocation device according to claim 1, further comprising a scheduled traveling area estimation unit configured to estimate the scheduled traveling area based on a destination included in the vehicle allocation request.

4. The vehicle allocation device according to claim 1, further comprising a learning unit configured to learn parameters collected by each of the vehicles, as teacher data from the plurality of vehicles.

5. The vehicle allocation device according to claim 4, wherein the vehicle selection unit is configured to acquire, from each of the vehicles, the learning progress calculated based on number of pieces of teacher data.

6. The vehicle allocation device according to claim 1, wherein
the parameters are parameters depending on the predetermined area, and
the parameters include air temperature, humidity, air pressure, a grade, altitude, an intake air amount of an engine, ignition timing of the engine, and an exhaust gas temperature of the engine.

7. A vehicle adapted to be allocated by a vehicle allocation device in response to a vehicle allocation request from a terminal of a user, the vehicle comprising
circuitry configured to:
learn an input/output relationship of parameters depending on a predetermined area; and
acquire a vehicle allocation instruction from the vehicle allocation device in a case where learning progress of an input/output relationship of parameters depending on a scheduled traveling area where the user is traveling is relatively small compared to other vehicles to be allocated.

8. The vehicle according to claim 7, wherein the circuitry is configured to acquire the vehicle allocation instruction from the vehicle allocation device in a case where the learning progress of the input/output relationship of the parameters depending on the scheduled traveling area where the user is traveling is smallest compared to the other vehicles to be allocated.

9. The vehicle according to claim 7, wherein the circuitry is further configured to:
collect teacher data including an input parameter and an output parameter depending on a predetermined area;
calculate the learning progress based on number of pieces of the teacher data; and
output the calculated learning progress to the vehicle allocation device.

10. The vehicle according to claim 7, wherein the parameters are parameters depending on the predetermined area, and include air temperature, humidity, air pressure, a grade, altitude, an intake air amount of an engine, ignition timing of the engine, and an exhaust gas temperature of the engine.

11. A terminal for making a vehicle allocation request to a vehicle allocation device, the terminal comprising:
a vehicle allocation reservation unit configured to
receive a vehicle allocation reservation from a user,
output the vehicle allocation request to the vehicle allocation device based on the vehicle allocation reservation, and
acquire, by outputting the vehicle allocation request to the vehicle allocation device, as allocation-scheduled vehicle information, information related to a vehicle that is selected from a plurality of vehicles learning an input/output relationship of parameters depending on a predetermined area and that has relatively small learning progress of an input/output relationship of parameters depending on a scheduled traveling area where the user is traveling.

12. The terminal according to claim 11, wherein the vehicle allocation reservation unit is configured to acquire, by outputting the vehicle allocation request to the vehicle allocation device, as allocation-scheduled vehicle information, information related to a vehicle that is selected from the plurality of vehicles learning the input/output relationship of the parameters depending on the predetermined area and that has the smallest learning progress of the input/output relationship of the parameters depending on the scheduled traveling area where the user is traveling.

13. The terminal according to claim 11, wherein the parameters are parameters depending on the predetermined area, and include air temperature, humidity, air pressure, a grade, altitude, an intake air amount of an engine, ignition timing of the engine, and an exhaust gas temperature of the engine.
